(19) United States
(12) Patent Application Publication
(10) Pub. No.: US 2013/0115495 A1
(43) Pub. Date: May 9, 2013

(54) LITHIUM PRIMARY BATTERY

(71) Applicants: Shinichiro Tahara, Osaka (JP); Toshiyuki Shimizu, Osaka (JP)

(72) Inventors: Shinichiro Tahara, Osaka (JP); Toshiyuki Shimizu, Osaka (JP)

(73) Assignee: PANASONIC CORPORATION, Osaka (JP)

(21) Appl. No.: 13/808,246

(22) PCT Filed: Mar. 29, 2012
(86) PCT No.: PCT/JP2012/002187

§ 371 Date: Jan. 3, 2013

(30) Foreign Application Priority Data
Mar. 30, 2011 (JP) 2011-075055

(51) Int. Cl. H01M 6/16; H01M 6/10

(52) U.S. Cl. 429/94; 429/211

(57) ABSTRACT

Disclosed is a lithium primary battery including a positive electrode, a negative electrode, a separator interposed therebetween, and a non-aqueous electrolyte. The positive electrode includes: a positive electrode mixture layer which includes fluorinated graphite as a positive electrode active material; and a positive electrode current collector to which the positive electrode mixture layer is attached, the current collector including stainless steel which contains niobium. The negative electrode includes, as a negative electrode active material, lithium metal or a lithium alloy. The content of niobium in the stainless steel is preferably 0.2 mass % or more, and the separator thickness can be made 50 μm or less.

### TECHNICAL FIELD

The present invention relates to a lithium primary battery which uses fluorinated graphite as a positive electrode active material, and particularly, to an improvement of a current collector for a positive electrode.

### BACKGROUND ART

Lithium primary batteries, which include a light metal such as lithium as the negative electrode active material and a compound such as manganese dioxide or fluorinated graphite as the positive electrode active material, have excellent features such as high voltage, high energy density, and low self discharge. They are thus used in a number of electronic devices. Also, lithium primary batteries have a remarkably long storage life, and are capable of long-term storage for as long as ten years or more at room temperature. They are thus widely used as the main power source and memory back-up power source for various meters.

Among lithium primary batteries, those which include, as the positive electrode active material, fluorinated graphite obtained by allowing a carbon material to react with fluorine gas at a high temperature in the range of 200 to 700° C.; and as the negative electrode active material, lithium metal or a lithium alloy, are known to have excellent thermal stability and chemical stability, as well as excellent long-term storage characteristics. Furthermore, use of fluorinated graphite enables obtaining lithium primary batteries having a high capacity, due to fluorinated graphite having a capacity density of about 864 mAh/g.

In recent years, lithium primary batteries are also beginning to be used in vehicles, industrial equipment, etc.; and a wide range of operating temperatures, ranging from high to low temperatures, is required for their intended use. However, fluorinated graphite as the positive electrode active material in lithium primary batteries contains a trace amount of fluorine ions derived from a raw material. Therefore, when lithium primary batteries are stored at high temperatures, these fluorine ions react with a trace amount of moisture, thereby producing fluoric acid; and there is an occurrence of a phenomenon in which the fluoric acid causes the positive electrode current collector to corrode.

Thus, titanium metal has been used as the positive electrode current collector in conventional lithium primary batteries. This is because titanium metal has excellent chemical stability against fluorinated graphite serving as the positive electrode active material, and high corrosion resistance against the non-aqueous electrolyte. The high corrosion resistance is presumed to be due to a thin oxide film formed on the surface of titanium metal (c.f., Patent Literature 1).

Moreover, by heating and humidifying the positive electrode current collector made of titanium metal, it is possible to form an oxide film which has more stability. Formation of a stable oxide film not only prevents corrosion of the positive electrode current collector due to fluoric acid, but also makes internal resistance more stable (c.f., Patent Literature 2).

### PRIOR ART

### Patent Literature

[Patent Literature 1] Japanese Examined Patent Publication No. 52-45888
[Patent Literature 2] Japanese Laid-Open Patent Publication No. 2006-221834

### SUMMARY OF INVENTION

### Problem of Invention

However, at a high temperature range of 85° C. or higher, even when titanium metal is used as the positive electrode current collector, the oxide film on the titanium metal breaks, since the amount of fluoric acid produced increases. Therefore, when a lithium primary battery is stored at such a high temperature range, there is an occurrence of a phenomenon in which titanium dissolves into the non-aqueous electrolyte and is then deposited as dendrites on the surface of the lithium metal or lithium alloy serving as the negative electrode. The titanium deposited on the surface of the negative electrode penetrates through the separator, and becomes the cause of internal short-circuits.

Thus, measures have been taken for a conventional lithium primary battery, such as by using as the separator, two layers of bulky non-woven fabrics made of polypropylene stacked on top of each other. Therefore, for a conventional lithium primary battery, it was not possible to reduce separator thickness; and despite the fluorinated graphite having a high capacity density of 864 mAh/g, there was a limit to increasing the capacity of the battery as a whole.

The present invention is in view of the foregoing, and aims to provide a high-capacity lithium primary battery having excellent high-temperature storage characteristics, without the necessity to use a bulky separator.

### Solution to Problem

The present invention relates to a lithium primary battery comprising:

a positive electrode including a positive electrode mixture layer which includes fluorinated graphite as a positive electrode active material, and a positive electrode current collector to which the positive electrode mixture layer is attached;

a negative electrode including, as a negative electrode active material, lithium metal or a lithium alloy;

a separator interposed between the positive electrode and the negative electrode; and

a non-aqueous electrolyte,

wherein the positive electrode current collector comprises stainless steel containing niobium.

### Advantageous Effect of Invention

In the present invention, since the positive electrode current collector has high resistance against fluoric acid, concerns over occurrences of internal short-circuits can be made less. Thus, the separator is not required to be thick, making it possible to provide a lithium primary battery having high capacity and excellent high-temperature storage characteristics.

### BRIEF DESCRIPTION OF DRAWINGS

FIG. 1 is a front view of a vertical section of a lithium primary battery according to one embodiment of the present invention.

### DESCRIPTION OF EMBODIMENT

A lithium primary battery according to the present invention comprises an electrode assembly including a positive electrode and a negative electrode that are wound or stacked with a separator interposed therebetween, the positive electrode including: a positive electrode mixture layer which includes fluorinated graphite as a positive electrode active material, and a positive electrode current collector to which the positive electrode mixture layer is attached; and the negative electrode including, as a negative electrode active material, lithium metal or a lithium alloy. The electrode assembly, together with a non-aqueous electrolyte, is sealed inside a packaging body.

Herein, the positive electrode current collector is made of stainless steel containing niobium. The use of the stainless steel containing niobium prevents corrosion of the positive electrode current collector, and thus prevents a phenomenon in which metal dissolved from the positive electrode current collector is deposited on the surface of the lithium metal or lithium alloy serving as the negative electrode. Therefore, it is possible to obtain a lithium primary battery having excellent high-temperature storage characteristics.

With respect to the amount of niobium contained in the stainless steel to be used as the positive electrode current collector, even if the amount is small, an effect which corresponds to that certain amount can be obtained. However, it is preferable to use the stainless steel having a niobium content of 0.2 mass % or more. The niobium content of 0.2 mass % or more enables increase in the effect of preventing corrosion of the positive electrode current collector, and also, in the effect of improving high-temperature storage characteristics of the lithium primary battery.

The positive electrode current collector preferably takes the form of a sheet made of the niobium-containing stainless steel, and is particularly preferably a porous sheet having meshes or holes, in terms of facilitating maintaining of the positive electrode mixture layer. Specific examples of the porous sheet include an expanded metal, a net, and a punched metal.

The material of the separator is not particularly limited, as long as it can be used in lithium primary batteries in general. The separator thickness is preferably 50 μm or less, further preferably 10 μm or more and 50 μm or less, and particularly preferably 10 μm or more and 30 μm or less, in terms of increasing the capacity of the lithium primary battery. In the present invention, the positive electrode current collector is prevented from corrosion, thereby making it difficult for metal to be deposited as dendrites on the negative electrode surface. Therefore, even if the separator is made thin as above, the possibility of internal short-circuits occurring would be remarkably small.

In the following, a specific embodiment of the present invention will be described. However, it should be noted that the following embodiment is merely a part of a specific example of the present invention, and does not limit the technical scope of the present invention.

(Positive Electrode)

A positive electrode includes: a positive electrode mixture layer which includes fluorinated graphite as a positive electrode active material; and a positive electrode current collector to which the positive electrode mixture layer is attached. The positive electrode mixture layer is formed on both surfaces of the positive electrode current collector, for example, in sheet form, such that the positive electrode current collector becomes buried beneath the positive electrode mixture layers. In addition to the fluorinated graphite, the positive electrode mixture layer may include, as a binder, a resin material such as fluorocarbon resin. The positive electrode mixture layer may also include, as a conductive agent, a conductive material such as a carbon material.

The fluorinated graphite is obtained by allowing a carbon material, which is a staring material, to react with a fluorine material such as fluorine gas at a high temperature in the range of 200° C. to 700° C. That is, the carbon material and the fluorine material are made to react with one another, provided that the mole ratio between the carbon atom (C) and the fluorine atom (F) is 1:z, thereby enabling obtaining of an aggregate of carbon fluoride (CF_{z}) composed of the atoms of C and F bonding with one another at a ratio of 1:z. The carbon material (i.e., the starting material) is not particularly limited, and examples thereof include petroleum coke, graphite, and acetylene black.

The fluorinated graphite can be represented, for example, by the formula: (CFₓ)ₙ, where 0.25≦x≦1.15 and n is an integer greater than zero. The more the percentage of the fluorine atoms relative to the percentage of the carbon atoms (degree of fluorination) is relatively small, the smaller the capacity of the positive electrode active material but the higher the conductivity and the discharge potential, and thus, the C—F bonds are more stable. Conversely, the more the degree of fluorination is relatively large, the greater the capacity of the positive electrode active material but the smaller the conductivity and the discharge potential. Therefore, by using a mixture obtained by mixing together the fluorinated graphites with various degrees of fluorination, it is possible to control factors such as discharge potential, conductivity, and high current discharge characteristics.

In a volume-based particle size distribution for the fluorinated graphite, particle size D50 at 50% of the cumulative frequency is, for example, preferably 5 to 30 μm and further preferably 10 to 20 μm. D50 within the above range enables better dispersibility of the fluorinated graphite in the positive electrode mixture, and thus enables preparation of the positive electrode mixture having excellent quantitative balance between the fluorinated graphite and the binder, as well as that between the fluorinated graphite and the conductive agent.

The positive electrode current collector to which the positive electrode mixture layer is attached, is made of stainless steel containing niobium. The positive electrode active material has a potential of 3.0 to 3.6 V relative to lithium, and therefore, stainless steel which does not contain titanium, aluminum, or niobium and also on which a stable oxide film is formed within the above potential range, has been used conventionally as the material for the positive electrode current collector. However, at a high temperature range of 85° C. or higher, there is an increase in the amount of fluoric acid produced by interaction between the fluorinated graphite serving as the positive electrode active material and moisture in the non-aqueous electrolyte. Therefore, to obtain a lithium primary battery having excellent high-temperature storage characteristics, it is necessary to sufficiently consider corrosion resistance against fluoric acid, when selecting the material for the positive electrode current collector. Stainless steel not containing titanium, aluminum, or niobium is not sufficient in corrosion resistance against fluoric acid. Therefore, at the high temperature range of 85° or higher, metal elements dissolve out of the positive electrode current collector and into the non-aqueous electrolyte.

In contrast, the niobium-containing stainless steel is excellent in corrosion resistance against fluoric acid. This is because an oxide film of niobium is excellent in corrosion resistance against fluoric acid. The oxide film of niobium is formed on the surface of the niobium-containing stainless steel. Thus, the positive electrode current collector has improved corrosion resistance against fluoric acid, and even at the high temperature range of 85° C. or higher, there are little instances of metal dissolving out of the positive electrode current collector and into the non-aqueous electrolyte. This results in obtaining a lithium primary battery having excellent high-temperature storage characteristics.

It is preferable that the niobium content in the stainless steel used as the positive electrode current collector, is 0.2 mass % or more. This is because, by making the niobium content 0.2 mass % or more, it is possible to sufficiently form the oxide film of niobium on the surface of the stainless steel, and to reliably obtain the effect of improved corrosion resistance against fluoric acid. Thus, during high-temperature storage of the battery, the positive electrode current collector is prevented from corrosion, even when fluoric acid is produced in relatively large amounts due to fluorine ions and a trace amount of moisture reacting with one another.

However, conductivity of the stainless steel tends to decline when the niobium content in the stainless steel is increased. Therefore, the niobium content is preferably 1.0 mass % or less, in terms of preventing increase in internal resistance of the battery. If the niobium content in the stainless steel is 1.0 mass % or less, internal resistance of the battery would not serve to be a problem, technically. The niobium content in the stainless steel is further preferably 0.4 to 0.8 mass %, in terms of obtaining the effect of improving corrosion resistance of the positive electrode current collector against fluoric acid, and also in terms of obtaining a positive electrode having further smaller internal resistance.

The stainless steel serving as the base material to which niobium is added, is not particularly limited in kind. Examples thereof include ferritic, austenitic, martensitic, and austenitic-ferritic stainless steels.

(Method for Producing Positive Electrode)

The positive electrode is produced, for example, in the following manner.

First, fluorinated graphite, a conductive agent, and a binder are mixed so as to prepare a positive electrode mixture. The manner in which the fluorinated graphite, the conductive agent, and the binder are mixed, is not particularly limited. However, it is preferable, for example, to first, mix the fluorinated graphite and the conductive agent by wet or dry mixing; and then, add the binder and a proper amount of water to the obtained mixture, followed by kneading, so as to prepare a wet positive electrode mixture.

For the conductive agent, it is preferable to use graphite powder of artificial graphite, natural graphite, or the like. It is also preferable to use a mixture obtained by mixing graphite powder together with carbon black such as acetylene black. The amount of the conductive agent to be blended is acceptable, as along as it is such by which a conductive path can be sufficiently formed in the positive electrode, such that electric resistance can be reduced while the content of the fluorinated graphite is maintained to be high. For example, it is preferable to blend 5 to 15 parts by mass of the conductive agent into 100 parts by mass of the fluorinated graphite.

The binder may be a resin material that is stable at the positive electrode potential; and that has binding properties for binding the active material particles to one another, or for binding the active material particle and the positive electrode current collector. Particularly, a fluorocarbon resin such as polytetrafluoroethylene is preferably used. The amount of the binder to be blended is acceptable, as long as it is such by which the positive electrode strength is maintained, while the content of the fluorinated graphite is maintained to be high. For example, it is preferable to blend 10 to 25 parts by mass of the binder into 100 parts by mass of the fluorinated graphite.

Next, the pores of the positive electrode current collector which is, for example, a porous sheet, are filled with the positive electrode mixture, and the resultant is then rolled. The porous sheet is made of the niobium-containing stainless steel. Specifically, the wet positive electrode mixture, together with the positive electrode current collector, is passed through a pair of rollers, the rollers facing each other such that the directions of their respective axes are in parallel. This allows the pores of the porous sheet to be filled with the positive electrode mixture, and also allows both surfaces of the porous sheet to have a layer of the positive electrode mixture formed thereon. The obtained electrode precursor is then dried, rolled to a desired thickness, and then cut to a predetermined size, so as to obtain a positive electrode.

(Negative Electrode)

Examples of a negative electrode include lithium metal; and lithium alloys such as a Li—Al alloy, a Li—Sn alloy, a Li—NiSi alloy, and a Li—Pb alloy. Any one of these, molded in sheet form, can be used directly as the negative electrode. Among the above lithium alloys, Li—Al alloy is preferable. The content of the metal elements contained in the lithium alloy, other than lithium, is preferably 0.2 to 15 mass %, in terms of securing discharge capacity and making internal resistance stable. The lithium metal or lithium alloy is molded to have an arbitrary shape and thickness, in accordance with the shape, size, and standardized performance of a lithium primary battery as the final product.

(Separator)

A separator may be a porous sheet made of an insulating material having resistance against the internal environment of a lithium primary battery. Specific examples thereof include a non-woven fabric made of synthetic resin and a microporous film made of synthetic resin. Examples of the synthetic resin used for the non-woven fabric include polypropylene, polyphenylene sulfide, and polybutylene terephthalate. Particularly, polyphenylene sulfide and polybutylene terephthalate are excellent in high temperature resistance, solvent resistance, and electrolyte-retaining ability. Examples of the synthetic resin used for the microporous film include polyethylene and polypropylene.

The separator thickness is preferably 10 μm or more and 50 μm or less. By making the separator thickness 50 μm or less, the proportion by volume of the separator in the battery becomes smaller; and thus, the proportion by volume of the positive electrode and that of the negative electrode therein become larger. This results in obtaining a battery with a larger discharge capacity. Since the positive electrode current collector has a high corrosion resistance, even when the separator having a thickness of 50 μm or less is used, metal is not deposited as dendrites on the negative electrode surface. Thus, internal short-circuits do not occur easily. Also, by making the separator thickness 10 μm or more, even when damage is caused to the separator during battery production due to roughness of the positive electrode surface, there is less possibility of the insulating properties of the separator becoming locally insufficient.

(Non-Aqueous Electrolyte)

A non-aqueous electrolyte is a non-aqueous solvent in which a lithium salt is dissolved, the lithium salt serving as a supporting salt. The non-aqueous solvent is not particularly limited as long as it is an organic solvent capable of typical use as a non-aqueous electrolyte for lithium primary batteries, and examples thereof include γ-butyrolactone, propylene carbonate, ethylene carbonate, and 1,2-dimethoxyethane.

Examples of the lithium salt include lithium tetrafluoroborate, lithium hexafluorophosphate, and lithium trifluoromethanesulfonate, and also, compounds having imide bonds in their molecular structure, such as lithium bis(trifluoromethyl sulfonyl)imide (LiN(CF₃SO₂)₂), lithium bis(pentafluoroethyl sulfonyl)imide (LiN(C₂F₅SO₂)₂)₂, and lithium(trifluoromethyl sulfonyl)(nonafluorobutyl sulfonyl)imide (LiN(CF₃SO₂)(C₄F₉SO₂)).

(Cylindrical Battery)

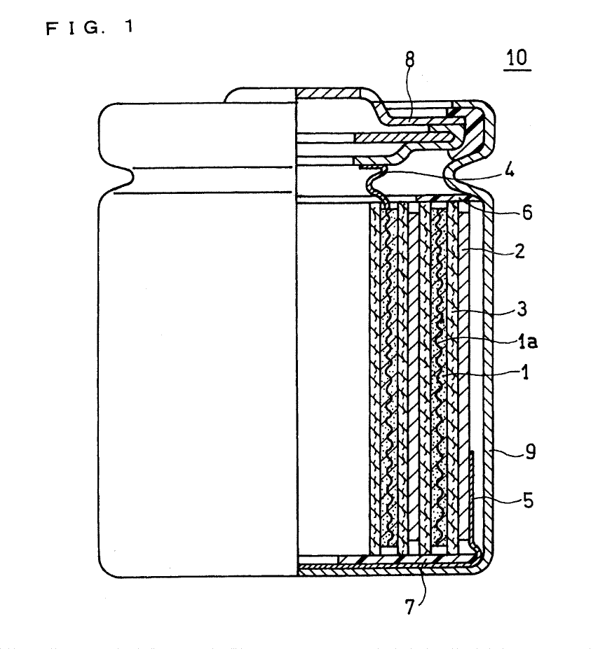

FIG. 1 is a front view of a vertical section of a lithium primary battery according to one embodiment of the present invention. The cylindrical lithium primary battery 10 comprises: a positive electrode 1 in strip form which includes fluorinated graphite as a positive electrode active material; and a negative electrode 2 in strip form which is a sheet of lithium metal serving as a negative electrode active material, or a sheet of a lithium alloy serving as the same. The positive electrode 1 and the negative electrode 2 are spirally wound with a separator 2 interposed therebetween, thereby forming a columnar electrode assembly. The electrode assembly, together with a non-aqueous electrolyte (not illustrated), is housed inside a battery can 9 having an opening and a bottom. To prevent internal short-circuits, an upper insulating plate 6 and a lower insulating plate 7 are disposed at the upper portion and the lower portion of the electrode assembly, respectively.

The positive electrode 1 includes, near its center in the thickness direction, a positive electrode current collector 1a in sheet form. The positive electrode current collector 1a is an expanded metal, a net, a punched metal, or the like, made of niobium-containing stainless steel. The positive electrode 1 has a part where the positive electrode mixture layer is peeled off such that the positive electrode current collector 1a is exposed, and one end of a positive lead 4 is welded to the exposed part. With respect to the negative electrode 2, one end of a negative lead 5 is welded directly to the negative electrode surface. The other end of the negative lead 5 is welded to the inner surface of the battery can 9. The other end of the positive lead 4 is welded to a sealing plate 8 which serves to seal the opening of the battery can 9. The sealing plate 8 and the battery can 9 constitute the outer packaging body of the lithium primary battery.

Next, the present invention will be described in more detail with reference to Examples. However, note that the present invention is not limited to these Examples.

### Example 1

(i) Positive Electrode

Ten parts by mass of graphite serving as a conductive agent and 20 parts by mass of polytetrafluoroethylene serving as a binder, were mixed into 100 parts by mass of fluorinated graphite serving as a positive electrode active material. Then, pure water and a surfactant were added to the obtained mixture, followed by kneading, thereby preparing a wet positive electrode mixture.

Next, the wet positive electrode mixture, together with a positive electrode current collector 1a being a 0.1 mm-thick expanded metal made of ferritic stainless steel (SUS430) containing 0.5 mass % of niobium, was passed through a pair of rollers rotating at uniform speed. This allowed the holes of the expanded metal to be filled with the positive electrode mixture, and also allowed both surfaces of the expanded metal to be covered with a layer of the positive electrode mixture, thereby producing an electrode precursor. Thereafter, the electrode precursor was dried, rolled to a thickness of 0.3 mm with use of a roll press machine, and then cut to a predetermined size (width: 19 mm, length: 175 mm), thereby obtaining a positive electrode 1. The positive electrode mixture was peeled off from one part of the positive electrode 1 so as to expose the positive electrode current collector, and a positive lead 4 was welded to the exposed part.

(ii) Negative Electrode

A 0.20 mm-thick lithium metal plate was cut to a predetermined size (width: 17 mm, length: 195 mm), to be used as a negative electrode 2. A negative lead 5 was connected to the negative electrode 2.

(iii) Electrode Assembly

The positive electrode 1 and the negative electrode 2 were spirally wound with a separator 3 interposed therebetween, the separator 3 being a 25 μm-thick microporous film made of polypropylene, thereby producing a columnar electrode assembly.

(iv) Non-Aqueous Electrolyte

Lithium tetrafluoroborate (LiBF₄) serving as a lithium salt was dissolved at a concentration of 1 mol/L, in a mixed non-aqueous solvent containing γ-butyrolactone and trioctyl phosphate serving as a surfactant (trioctyl phosphate content: 5 mass %), thereby preparing a non-aqueous electrolyte.

(i) Assembling of Cylindrical Battery

The obtained electrode assembly, with a ring-shaped lower insulating plate 7 disposed at its bottom, was inserted into a cylindrical battery can 9 having a bottom. Thereafter, a positive lead 4, welded to the positive electrode current collector 1a in the positive electrode 1, was connected to the inner surface of a sealing plate 8; and a negative lead 5, connected to the negative electrode 2, was connected to the inner surface of the bottom of the battery can 9.

Next, the non-aqueous electrolyte was injected into the battery can 9; and furthermore, an upper insulating plate 6 was disposed on top of the electrode assembly. Thereafter, the opening of the battery can 9 was sealed with the sealing plate 8, thereby completing a cylindrical lithium primary battery (Battery A) having a diameter of 14 mm and a height of 25 mm, as illustrated in FIG. 1.

### Example 2

A lithium primary battery (Battery B) was produced in the same manner as Battery A, with the exception of using, as the positive electrode current collector, a 0.1 mm-thick expanded metal made of ferritic stainless steel (SUS430) containing 0.2 mass % of niobium.

### Example 3

A lithium primary battery (Battery C) was produced in the same manner as Battery A, with the exception of using, as the positive electrode current collector, a 0.1 mm-thick expanded metal made of ferritic stainless steel (SUS430) containing 1.0 mass % of niobium.

### Example 4

A lithium primary battery (Battery D) was produced in the same manner as Battery A, with the exception of changing the length of the positive electrode 1 to 165 mm; changing the length of the negative electrode 2 to 185 mm; and changing the separator interposed between the positive electrode 1 and the negative electrode 2, to a 50 μm-thick microporous film made of polypropylene.

### Example 5

A lithium primary battery (Battery E) was produced in the same manner as Battery A, with the exception of changing the length of the positive electrode 1 to 185 mm; changing the length of the negative electrode 2 to 205 mm; and changing the separator 3 to be interposed between the positive electrode 1 and the negative electrode 2, to a 10 μm-thick microporous film made of polypropylene.

### Comparative Example 1

A lithium primary battery (Battery F) was produced in the same manner as Battery A, with the exception of using, as the positive electrode current collector, a 0.1 mm-thick expanded metal made of ferritic stainless steel (SUS430) not containing niobium.

### Example 6

A lithium primary battery (Battery G) was produced in the same manner as Battery A, with the exception of using, as the positive electrode current collector, a 0.1 mm-thick expanded metal made of ferritic stainless steel (SUS430) containing 0.1 mass % of niobium.

### Comparative Example 2

A lithium primary battery (Battery H) was produced in the same manner as Battery A, with the exception of using, as the positive electrode current collector, a 0.1 mm-thick expanded metal made of ferritic stainless steel (SUS430) not containing niobium; changing the length of the positive electrode 1 to 150 mm; changing the negative electrode 2 to 170 mm; and changing the separator 3 interposed between the positive electrode 1 and the negative electrode 2, to a 50 μm-thick microporous film made of polypropylene.

### Comparative Example 3

A lithium primary battery (Battery I) was produced in the same manner as Battery A, with the exception of using, as the positive electrode current collector, a 0.1 mm-thick expanded metal made of ferrtic stainless steel (SUS430) not containing niobium; changing the length of the positive electrode 1 to 135 mm; changing the length of the negative electrode 2 to 155 mm; and changing the separator 3 interposed between the positive electrode 1 and the negative electrode 2, to a 80 μm-thick microporous film made of polypropylene.

With respect to Batteries A to J produced in the foregoing manner, a storage test at 100° C. was performed, and measurements were made on the battery for open-circuit voltage and internal resistance after one month. The internal resistance was measured by means of sinusoidal alternating current of 1 kHz and by means of passing current of 0.1 mA. The test results are shown on Table 1.

TABLE 1

| | | | | | One-month |
|---|---|---|---|---|---|
| | | | | | Storage at |
| | | | Initial State | | 100° C. |
| | Nb | Separator | Circuit | Internal | Circuit |
| | Content | Thickness | Voltage | Resistance | Voltage |
| | (mass %) | (μm) | (V) | (Ω) | (V) |
| Battery A | 0.5 | 25 | 3.45 | 0.6 | 3.40 |
| Battery B | 0.2 | 25 | 3.44 | 0.6 | 3.40 |
| Battery C | 1.0 | 25 | 3.45 | 0.8 | 3.40 |
| Battery D | 0.5 | 50 | 3.45 | 0.6 | 3.40 |
| Battery E | 0.5 | 10 | 3.45 | 0.5 | 3.40 |
| Battery F | 0.0 | 25 | 3.40 | 0.6 | 2.90 |
| Battery G | 0.1 | 25 | 3.43 | 0.6 | 3.15 |
| Battery H | 0.0 | 50 | 3.42 | 0.8 | 3.15 |
| Battery I | 0.0 | 80 | 3.42 | 1.2 | 3.38 |

With respect to Battery F of Comparative Example 1, there was a remarkable decline in open-circuit voltage after the one-month storage at 100° C. This is presumably because metal dissolved from the positive electrode current collector due to fluoric acid produced inside the battery and was deposited on the surface of the lithium metal serving as the negative electrode, thus resulting in occurrence of an internal short-circuit.

With respect to Battery G of Example 6, there was a decline in open-circuit voltage after the one-month storage at 100° C. However, despite the separator thickness being 25 μm, the open-circuit voltage was maintained at the same level as that of the Battery H of Comparative Example 2 having the separator thickness of 50 μm.

With respect to Battery I of Comparative Example 3, a decline was not observed in open-circuit voltage after the one-month storage at 100° C. However, the separator was remarkably thick, being 80 μm; and the volume of the separator 3 inside the battery was large. Therefore, it was necessary to make the positive electrode length and the negative electrode length 40 mm shorter, respectively, than those in the case of using a 25 μm-thick separator. Thus, in addition to the large internal resistance of the battery, discharge capacity became smaller, although this is not shown in Table 1.

With respect to Batteries A to E of Examples 1 to 5, characteristics in the initial state were good. Also, a decline was not observed in open-circuit voltage after the one-month storage at 100° C. That is, it was found that even when the separator is made sufficiently thin for higher capacity, internal short-circuits do not easily occur, and high-temperature storage characteristics are excellent.

### INDUSTRIAL APPLICABILITY

The lithium primary battery according to the present invention has high capacity and excellent high-temperature storage characteristics. Therefore, it is particularly useful when applied to vehicles, industrial equipment, etc. which require a wide range of operating temperatures, ranging from high to low temperatures.

### EXPLANATION OF REFERENCE NUMERALS

1 positive electrode
1a positive electrode current collector
2 negative electrode
3 separator
4 positive lead
5 negative lead
6 upper insulating plate
7 lower insulating plate
8 sealing plate
9 battery can
10 lithium primary battery

1. A lithium primary battery comprising:
a positive electrode including a positive electrode mixture layer which includes fluorinated graphite as a positive electrode active material, and a positive electrode current collector to which the positive electrode mixture layer is attached;
a negative electrode including, as a negative electrode active material, lithium metal or a lithium alloy;
a separator interposed between the positive electrode and the negative electrode; and
a non-aqueous electrolyte,
wherein the positive electrode current collector comprises stainless steel containing niobium.

2. The lithium primary battery in accordance with claim 1, wherein a content of niobium in the stainless steel is 0.2 mass % or more.

3. The lithium primary battery in accordance with claim 2, wherein the content of niobium in the stainless steel is 0.2 mass % or more and 1 mass % or less.

4. The lithium primary battery in accordance with claim 1, wherein the positive electrode current collector is a porous sheet made of the stainless steel having meshes or holes.

5. The lithium primary battery in accordance with claim 1, wherein a thickness of the separator is 10 μm or more and 50 μm or less.

6. The lithium primary battery in accordance with claim 1, comprising a columnar electrode assembly including the positive electrode and the negative electrode that are wound with the separator interposed therebetween.
